(19) United States
(12) Patent Application Publication
(10) Pub. No.: US 2008/0092683 A1
(43) Pub. Date: Apr. 24, 2008

(54) Venturi passageway for a steering assembly

(76) Inventors: John W. Spetz, Morristown, TN (US); Phillip A. Bishop, Kingsport, TN (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/650,200

(22) Filed: Jan. 5, 2007

Related U.S. Application Data
(63) Continuation-in-part of application No. 11/252,095, filed on Oct. 17, 2005.

(51) Int. Cl. F16H 35/00

(52) U.S. Cl. 74/388 PS

(57) ABSTRACT

A venturi passage for a steering gear assembly is provided that includes a rack bushing having an outer surface. A rack bushing main fluid channel extends circumferentially about the outer surface of the rack bushing. A steering gear housing is disposed at a distal end from the rack bushing. A rack tube sealingly engages the outer surface of the rack bushing. A portion of the rack tube overlaps the rack bushing main fluid channel of the rack bushing. The rack tube includes a first aperture extending through a wall of the rack tube and is in fluid communication with the rack bushing main fluid channel. A first fitting extends radially outward from the rack tube and is in fluid communication with the rack bushing main fluid channel through the first aperture. The rack bushing main channel maintains fluid communication between the first fitting and the rack bushing extended fluid channel.

### CROSS-REFERENCE TO RELATED APPLICATIONS

This application is a continuation-in-part of application Ser. No. 11/252,095 filed Oct. 17, 2005.

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Not Applicable

### BACKGROUND OF THE INVENTION

1. Field of the Invention

This invention relates in general to steering systems, and more specifically, to a steering gear housing and rack tube assembly.

2. Background of Related Art

Rack and pinion steering gear assemblies typically include a steering gear housing that houses a steering gear. The steering gear housing is coupled to a rack tube that includes a rack. The rack is coupled to the tie rods and includes teeth that mesh with the steering gear for moving the rack laterally in either direction. The rack also includes a piston coupled about the exterior surface of the rack. The piston is larger than the outer diameter of the rack but smaller than the inner diameter of the rack tube. Seals are disposed at each end of the rack for creating respective fluid chambers on each side of the rack. Pressurized hydraulic fluid is provided to and from each chamber for assisting the driver in moving the rack. As the steering system senses the drivers input on the steering wheel, hydraulic fluid is provided to a respective chamber for pressurizing the chamber and exerting a force on a respective side of the piston for assisting the driver in moving the rack.

Pressure lines provide pressurized hydraulic fluid to and from each of the respective chambers. Typically the pressure lines are coupled to an adapter fitting that is connected to a respective portion of each chamber for providing pressurized hydraulic fluid directly into the chamber. The rack housing includes apertures which the adapter fitting is coupled to for allowing hydraulic fluid flow into and out of a respective chamber. A disadvantage in coupling the adapter fitting directly to the region directly over a respective chamber is that the piston must maintain a minimum distance from the adapter fitting coupled about the aperture thereby creating a non-restricted travel region. Otherwise damage (such as uneven or premature wear of the piston) may occur from the piston traveling over the opening to the adapter fitting which caused from weld deformation about the opening. Current design standards require that the piston maintain a predetermined distance (e.g., 20 mm) from each fitting. Since maximum length of the steering gear assembly is limited by the distance between the ball centers of the inner tie rod pivots (as dictated by the vehicle design), such restrictions caused by the restricted travel region further reduces the stroke (i.e., travel) of the steering gear. As a result of this restriction, the steering gear assembly has reduced travel of the rack and an increase in the overall length of the rack tube for supplementing the unused travel portion of the rack tube.

When locating the adapter fitting it is desirable to mount the adapter fitting and its respective pressure line on an uppermost circumferential portion of the rack housing for purging a respective chamber of entrapped gas. Gases (e.g., air) entrapped within a chamber will typically rise to an uppermost unobstructed portion of the chamber. Having the adapter fitting and respective pressure line adapted to the tubular housing at the uppermost portion allows the steering system to naturally bleed any entrapped gas from the chamber when the hydraulic fluid is withdrawn from the chamber. However, due to packaging constraints with components, the vehicle body, and the framework, such interference conditions do not typically allow the adapter fitting and pressure line to be mounted to the uppermost portion of the tube housing. Rather, the connection to the tube housing must be made at a circumferential position other than the uppermost portion of the rack housing where sufficient package space allows such a connection.

### BRIEF SUMMARY OF THE INVENTION

The present invention has the advantage of coupling a hydraulic fluid line to a non-uppermost portion of a rack tube while still being capable of bleeding entrapped gases out of the pressure chamber within the rack housing. The present invention further has the advantage of coupling the pressure line at a location axially offset from the pressure chamber which allows for a smaller steering gear design with increased rack travel.

In one aspect of the present invention, a steering gear assembly is provided that includes a rack bushing having an outer surface including a rack bushing main fluid channel extending circumferentially about the outer surface of the rack bushing. A steering gear housing is disposed at a distal end from the rack bushing. A rack tube sealingly engages the outer surface of the rack bushing. A portion of the rack tube overlaps the rack bushing main fluid channel of the rack bushing. The rack tube includes a first aperture and a second aperture extending through a wall of the rack tube. The first aperture is in fluid communication with the rack bushing main fluid channel. A first fitting and a second fitting extends radially outward from the rack tube. The first fitting is in fluid communication with the rack bushing main fluid channel through the first aperture. A rack is slidingly disposed in the rack tube, the rack bushing, and the steering gear housing. A piston is coupled to the rack. A first hydraulic chamber is formed within the rack tube between the rack bushing and the piston. A rack seal is disposed about the rack at an end portion of the steering gear housing defining a second hydraulic chamber within the rack tube between the rack seal and the piston. A rack bushing extended fluid channel extends axially along the outer surface of the steering gear housing from the rack bushing main fluid channel to the second hydraulic chamber for allowing fluid flow between the first fitting and the first hydraulic chamber.

In yet another aspect of the present invention, a steering gear assembly is provided that includes a steering gear housing having an outer surface including a steering gear housing main fluid channel extending circumferentially about the outer surface of the steering gear housing. A rack tube sealingly engages the outer surface of the steering gear housing. A portion of the rack tube overlaps the main channel of the steering gear housing. The rack tube includes a first aperture and a second aperture extending through a wall of the rack tube. The first aperture is in fluid communication with the steering gear housing main fluid channel. A first fitting and a second fitting extends radially outward from the rack tube. The second fitting is in fluid communication with the steering gear housing main fluid channel through the second aperture. A rack is slidingly disposed in the rack tube and the steering gear housing. A rack bushing is disposed at a distal end of the rack from the steering gear housing. A piston is coupled to the rack. A first hydraulic chamber is formed between track bushing and the piston. A rack seal is disposed about the rack at an end portion of the steering gear housing defining a second hydraulic chamber within the rack tube between the rack seal and the piston. A steering gear housing extended fluid channel extends axially along the outer surface of the steering gear housing from the steering gear housing main fluid channel to the second hydraulic chamber for allowing fluid flow between the second fitting and the second chamber.

In yet another aspect of the present invention, a venturi passage is provided for a steering gear assembly that includes a rack bushing having an outer surface that includes a rack bushing main fluid channel extending circumferentially about the outer surface of the rack bushing. A steering gear housing is disposed at a distal end from the rack bushing. A rack tube sealingly engages the outer surface of the rack bushing. A portion of the rack tube overlaps the rack bushing main fluid channel of the rack bushing. The rack tube including a first aperture extending through a wall of the rack tube. The first aperture is in fluid communication with the rack bushing main fluid channel. A first fitting extends radially outward from the rack tube. The first fitting is in fluid communication with the rack bushing main fluid channel through the first aperture. The rack bushing main channel maintains fluid communication between the first fitting and the rack bushing extended fluid channel.

The method is provided for forming a venturi passage in a steering gear assembly. A rack bushing main fluid channel is formed in a rack bushing. A rack bushing extended fluid channels is formed at an uppermost portion of the rack bushing that extends axially along the outer surface of the rack bushing from the rack bushing main fluid channel to an end of the rack bushing. The rack tube sealingly engages to the outer surface of the rack bushing. A portion of the rack tube overlaps the rack bushing main fluid channel and the rack bushing extended fluid channel of the rack bushing. A first fitting and a second fitting are coupled to the rack tube each extending radially outward from the rack tube. The first fitting is in fluid communication with the rack bushing main fluid channel. The first fitting is circumferentially spaced from the rack bushing extended fluid channel.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a steering gear assembly for a rack and pinion steering system of a vehicle.

FIG. 2 is a partial cross section, perspective view, taken along line A-A in FIG. 1.

FIG. 3 is a cross section taken along line A-A in FIG. 1.

FIG. 4 is a perspective view of a portion of the steering gear housing.

FIG. 5 is a cross section of the venturi passage, taken along line C-C in FIG. 3, illustrating fluid flow.

FIG. 6 is a partial cross section, perspective view, taken along line B-B in FIG. 1.

FIG. 7 is a cross section taken along line B-B in FIG. 1.

FIG. 8 is a perspective view of a portion of the steering gear housing.

FIG. 9 is a cross section of the venturi passage, taken along line D-D in FIG. 7, illustrating fluid flow.

### DETAILED DESCRIPTION OF THE PREFERRED EMBODIMENT

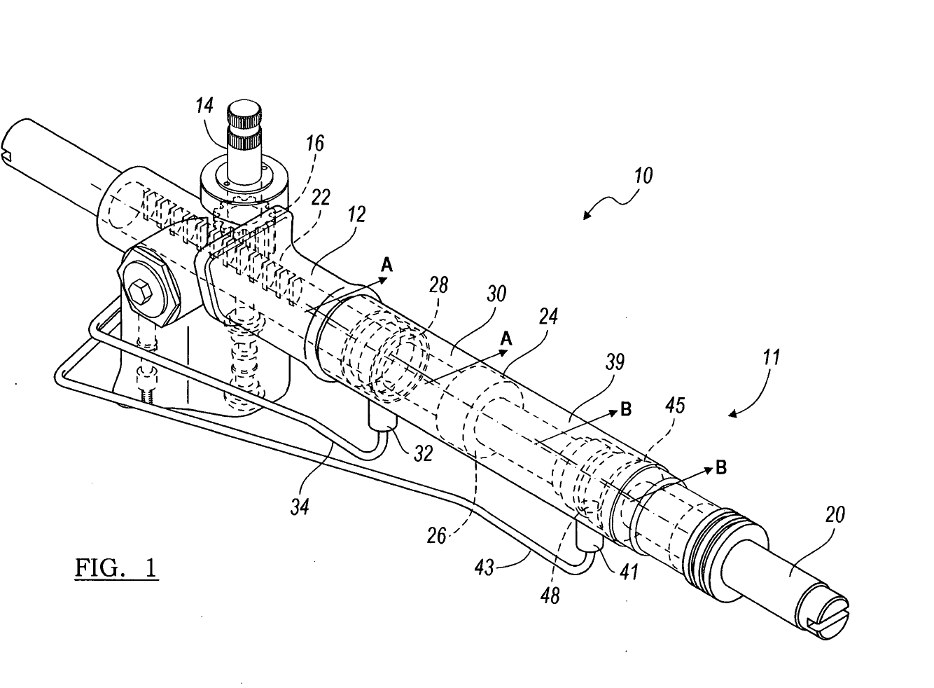

Referring now to the drawings, there is illustrated in FIG. 1 a steering assembly 10 for a rack and pinion steering system, indicated generally at 11, mounted to a frame of a vehicle (not shown). The steering assembly 10 includes a steering gear housing 12 that houses an input shaft 14. A first end of the input shaft 14 is coupled to a steering wheel (not shown) through conventional steering linkages (not shown) and receives rotational input from a driver of the vehicle. The input shaft 14 has a pinion gear 16 formed on a second end of the shaft 14.

The steering gear housing 12 also houses a rack 20. The rack 20 includes rack gear teeth 22 that mesh with the pinion gear 16 within the steering gear housing 12 for laterally displacing the rack 20 when the input shaft 14 is rotated. The opposite ends of the rack 20 each include a ball and socket joint (not shown) for pivotably connecting tie rods (not shown) to the rack 20. The tie rods are connected to steerable wheels (not shown) for steering the vehicle via the driver's manual input commands to the steering wheel.

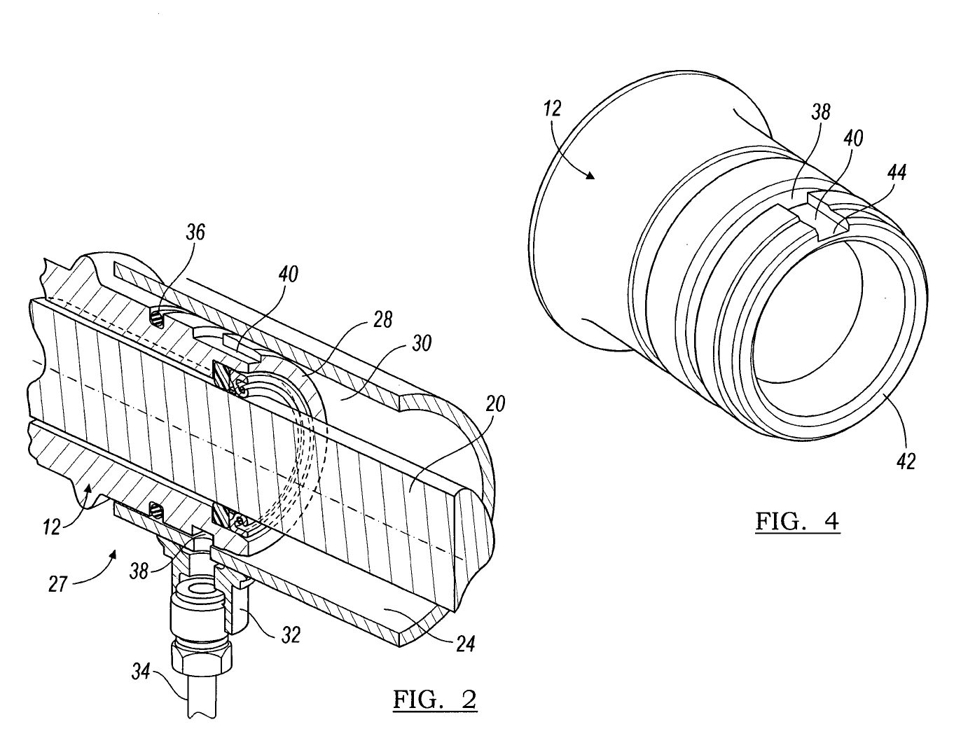

The steering assembly 10 further includes a rack tube 24 that overlaps with the steering gear housing 12. The rack tube 24 is sealingly coupled to the steering gear housing 12. The rack tube 24 also houses a portion of the rack tube 24 and steering gear housing 12. A piston 26 is affixed about an outer diameter of the rack 20 within the rack tube 24. A first rack seal 28 is disposed within the rack tube 24 at an end of the steering gear housing 12. A chamber 30 is formed in cooperation with the inner wall of the rack tube 24, rack seal 28, and piston 26. A first adapter fitting 32 is affixed to the rack tube 24 at a region where the rack tube 24 and steering gear housing 12 overlap. The first adapter fitting 32 is also coupled to a hydraulic fluid line 34 for allowing hydraulic fluid flow to and from the chamber 30 via a venturi passage (shown in FIG. 2). A rack bushing 45 is seated at an opposing end of the rack 20 for forming a chamber 39 in cooperation with the rack 20 and piston 26. A second adapter fitting 41 in cooperation with a hydraulic pressure line 43 are coupled to the rack tube 24 for providing hydraulic fluid to and from the chamber 39.

FIG. 2 and FIG. 3 illustrate cross section views of the venturi passage formed by the interconnection between the steering gear housing 12 and the rack tube 24. The rack 20 is shown disposed within the steering gear housing 12 and the rack tube 24. An overlap portion, generally shown at 27, illustrates the region where the rack tube 24 is interconnected to the steering gear housing 12. The rack seal 28 is mounted to the end portion of the steering gear housing 12. Preferably, the rack seal 28 is seated in a pocket formed in the end portion of the steering gear housing 12. An O-ring 36 is partially embedded within the exterior surface of the steering gear housing 12 for preventing hydraulic fluid from leaking between interconnection of the rack tube 24 and steering gear housing 12. The interconnection between the rack tube 24 and steering gear housing 12 may be made by a press fit connection or a slip fit connection and welded thereafter.

The first adapter fitting 32, having a bore therethrough, is affixed to the rack tube 24 and extends radially therefrom. The first adapter fitting 32 is preferably a weld stud that is welded to the rack tube 24. Alternatively, the first adapter fitting 32 may be affixed by other means, or integrally formed as part of the rack tube 24. An aperture 35 extends through the wall of the rack tube 24 at the point of attachment of the first adapter fitting 32. The axis of the aperture 35 is aligned with the axis of the bore of the first adapter fitting 32.

A steering gear housing main fluid channel 38 is formed circumferentially about an outer surface of the steering gear housing 12. A steering gear housing extended fluid channel 40 extends axially along the outer surface of the steering gear housing 12 from the main fluid channel to the chamber 30. In the preferred embodiment, the main fluid channel 38 extends the entire circumference about the outer surface of the steering gear housing 12. In alternative embodiments, the main fluid channel 38 extends about the outer surface of the steering gear housing 12 only between the first adapter fitting 32 and extended channel portion 40.

The main fluid channel 38 is axially aligned with the bore of the first adapter fitting 32 for allowing hydraulic fluid flow between the hydraulic pressure line 34 and the chamber 30. Preferably the extended fluid channel 40 is formed axially along an uppermost portion of the steering gear housing 12. Alternatively, the extended fluid channel 40 may be formed at a maximum of 45 degrees from the uppermost portion. Having the extended fluid channel 40 formed at or near the uppermost portion of the steering gear housing 12 allows entrapped gases to bleed out of the chamber 30 when hydraulic fluid is withdrawn from the chamber 30.

The venturi passageway formed by the main fluid channel 38 and the extended fluid channel 40 allows the first adapter fitting 32 and hydraulic pressure line 34 to be affixed at any circumferential location about the rack tube 24. This alleviates any concerns for packaging the first adapter fitting 32 and associated hydraulic pressure line 34 along the uppermost portion of the rack tube where an interference condition may exist. In addition, the venturi passageway allows the first adapter fitting 32 to be affixed to the rack tube 24 in the overlap region 27 between the rack tube 24 in the steering gear assembly 12 which is axially offset from the chamber 30. This eliminates any design standard requirement that the piston maintain a predetermined distance from the aperture 35 since the aperture is not formed directly about the chamber 30. The elimination of this restricted travel region allows a shorter steering gear to be produced relative to conventional steering gear assemblies, without a decrease in the distance the rack can travel.

In an alternative embodiment, the aperture through the rack tube and the adapter fitting may be axially offset from the main fluid channel. A secondary extended fluid channel may extend from the aperture and the adapter fitting to the main fluid channel for maintaining fluid communication between the fluid adapter fitting and the main fluid chamber.

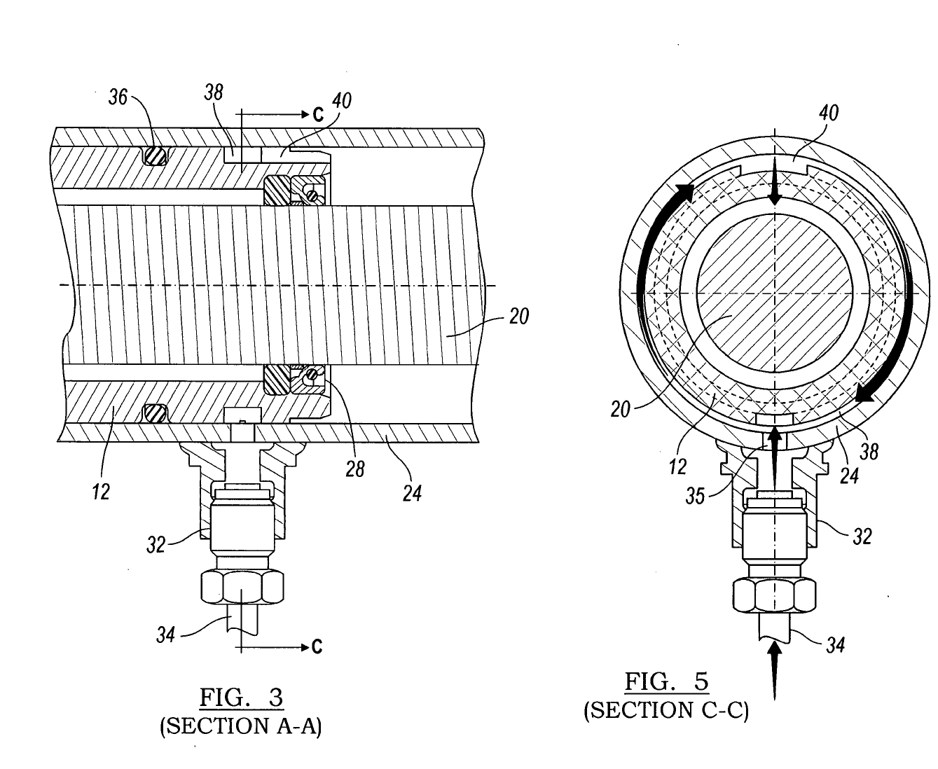

FIG. 4 illustrates a perspective view of a portion of the steering gear housing 12 illustrating the venturi passage formed in an end portion of the steering gear housing 12. The main fluid channel 38 is formed circumferentially about the exterior surface of the steering gear housing 12. The steering gear housing 12 forms three of the four sides of the main fluid channel 38. The fourth side (i.e., top) is formed by the inner wall of the rack tube 24 when the rack tube overlaps the steering gear housing 12 (as shown in FIGS. 1-3). The extended fluid channel 40 is shown formed along the uppermost portion of the steering gear housing 12. The extended fluid channel 40 extends axially to an end surface 42 of the steering gear housing 12. A top surface of the extended fluid channel 40 is also formed by the overlapping portion of the inner wall of the rack tube 24. An opening 44 formed in the end surface 42 of the steering gear housing 12 provides a portal for fluid to flow in and out of the chamber 30 (shown in FIGS. 1-3) via the extended fluid chamber portion 40.

FIG. 5 illustrates a cross section of the venturi passageway and corresponding flowpath. When hydraulic pressure is required to assist in moving the piston in the respective direction within the rack tube 24, pressurized hydraulic fluid is forced through the hydraulic pressure line 34 and first adapter fitting 32. The hydraulic fluid flows through the aperture 35 and into the main fluid channel 38. The hydraulic fluid flows from the main fluid channel 38 to the extended fluid channel 40 formed along the uppermost portion of the steering gear housing 12. Hydraulic fluid thereafter flows through the extended fluid channel 40 and into the chamber 30 (shown in FIG. 1) for pressurizing the chamber 30. The increased pressure exerts a force on the piston 26 (shown in FIG. 1) moving the piston 26 and rack 20.

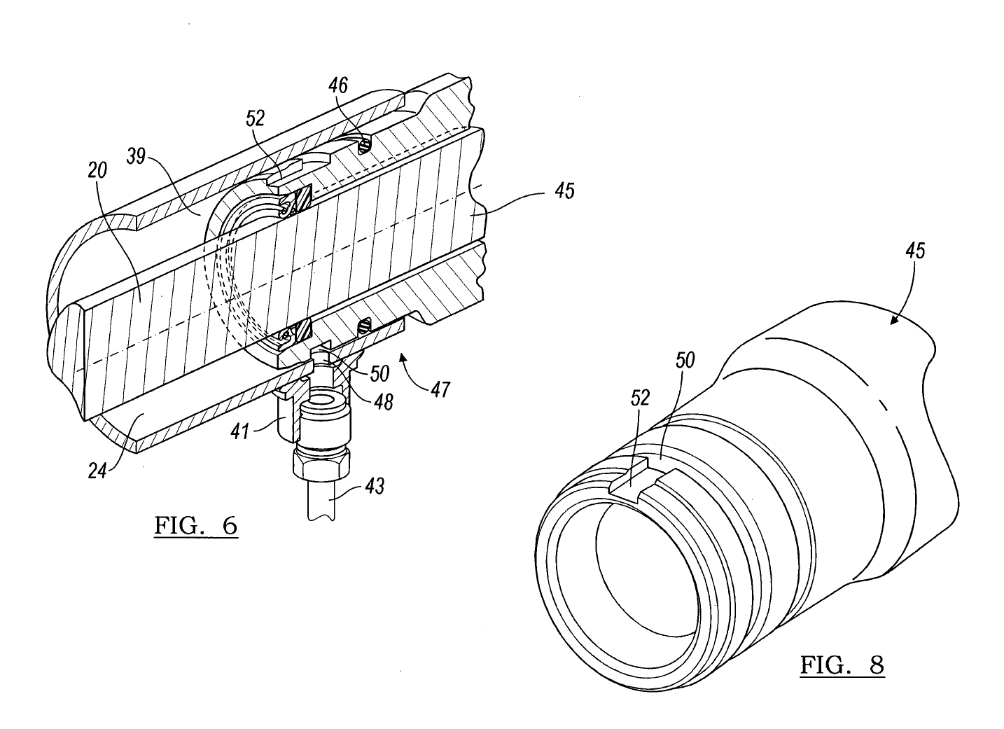

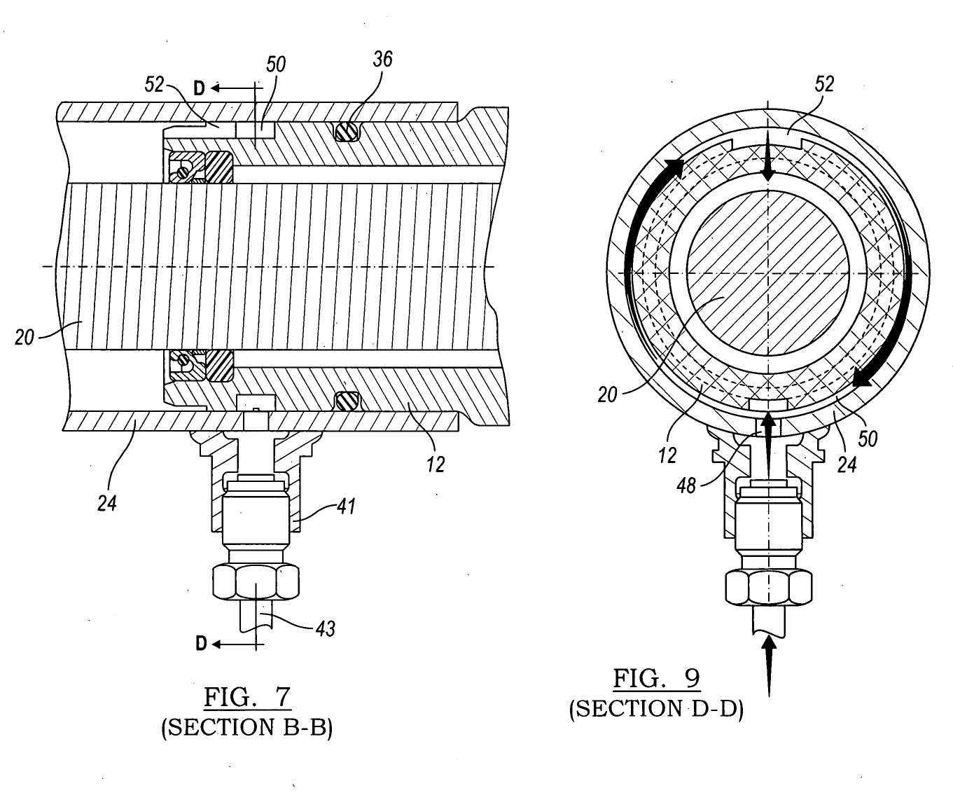

FIGS. 6-9 illustrate cross section views of the venturi passage of the rack bushing 45 formed by an overlap portion 47 between the rack bushing 45 and the rack tube 24. The venturi-passage of the rack bushing 45 has a substantially same design as the venturi-passage of the steering gear housing 12. The rack bushing 45 is mounted within the rack tube 24 at a distal end of the second chamber 38 from the piston 24. Preferably, the rack bushing 45 is seated in a pocket formed in the end portion of the rack tube 24. An o-ring 46 is partially embedded within the exterior surface of the rack bushing 45 for preventing hydraulic fluid from leaking between interconnection of the rack tube 24 and rack bushing 45.

The second adapter fitting 41, having a bore therethrough, is affixed to the rack tube 24 and extends radially therefrom. The second adapter fitting 41 is preferably a weld stud that is welded to the rack tube 24. Alternatively, the second adapter fitting 41 may be affixed by other means, or integrally formed as part of the rack tube 24. An aperture 48 extends through the wall of the rack tube 24 at the point of attachment of the second adapter fitting 41. The axis of the aperture 48 is aligned with the axis of the bore of the second adapter fitting 41.

A rack bushing main fluid channel 50 is formed circumferentially about an outer surface of the rack bushing 45. A rack bushing extended fluid channel 52 extends axially along the outer surface of the rack bushing 45 from the main fluid channel 50 to the second chamber 39. In the preferred embodiment, the main fluid channel 50 extends the entire circumference about the outer surface of the rack bushing 45. In alternative embodiments, the main fluid channel 50 extends about the outer surface of the rack bushing 45 only between the second adapter fitting 41 and extended fluid channel 52.

The main fluid channel 50 is axially aligned with the bore of the second adapter fitting 41 for allowing hydraulic fluid flow between the hydraulic pressure line 43 and the chamber 39. Preferably, the extended fluid channel 52 is formed axially along an uppermost portion of the steering gear housing 12. Alternatively, the extended fluid channel 52 may be formed at a maximum of 45 degrees from the uppermost portion. Having the extended fluid channel 52 formed at or near the uppermost portion of the rack bushing 45 allows entrapped gases to bleed out of the chamber 39 when hydraulic fluid is withdrawn from the chamber 39.

The venturi passageway formed by the main fluid channel 50 and the extended fluid channel 52 allows the adapter fitting 41 and hydraulic pressure line 43 to be affixed at any circumferential location about the rack tube 24. This alleviates any concerns for packaging the second adapter fitting 41 and associated hydraulic pressure line 43 along the uppermost portion of the rack tube where an interference condition may exist. In addition, the venturi passageway allows the second adapter fitting 41 to be affixed to the rack tube 24 in the overlap region 47 between the rack tube 24 in the rack bushing 45 which is axially offset from the chamber 39. This eliminates any design standard requirement that the piston maintain a predetermined distance from the aperture 45 since the aperture 45 is not formed directly about the chamber 39. The elimination of this restricted travel region allows a shorter steering gear to be produced relative to conventional steering gear assemblies, without a decrease in the distance the rack can travel.

The venturi passage of the rack bushing 45 functions in a substantially same manner as that described earlier for the venturi passage in the steering gear housing 12. It should be noted that either the venturi passage of the rack bushing 45 or the venturi passage of the steering gear housing 12 may be solely utilized in the steering assembly 10, or both venturi passages in the steering gear housing 12 and the rack bushing 45 may be utilized in a same respective steering assembly.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope. For example, the venture passageway may be used on both fluid chambers of the steering gear assembly.

What is claimed is:

1. A steering gear assembly comprising:
a rack bushing including an outer surface having a rack bushing main fluid channel extending circumferentially about the outer surface of the rack bushing;
a steering gear housing disposed at a distal end from the rack bushing;
a rack tube sealingly engaging the outer surface of the rack bushing wherein a portion of the rack tube overlaps the rack bushing main fluid channel of the rack bushing, the rack tube including a first aperture and a second aperture extending through a wall of the rack tube, the first aperture in fluid communication with the rack bushing main fluid channel, and a first fitting and a second fitting extending radially outward from the rack tube, the first fitting in fluid communication with the rack bushing main fluid channel through the first aperture;
a rack slidingly disposed in the rack tube, the rack bushing, and the steering gear housing;
a piston coupled to the rack;
a first hydraulic chamber formed within the rack tube between the rack bushing and the piston;
a rack seal disposed about the rack at an end portion of the steering gear housing defining a second hydraulic chamber within the rack tube between the rack seal and the piston;
a rack bushing extended fluid channel extending axially along the outer surface of the steering gear housing from the rack bushing main fluid channel to the second hydraulic chamber for allowing fluid flow between the first fitting and the first hydraulic chamber.

2. The steering gear assembly of claim 1 wherein the rack bushing extended fluid channel is U-shaped.

3. The steering assembly of claim 1 wherein the outer surface of the rack bushing has an uppermost portion, and the rack bushing extended fluid channel is located within 45 degrees from the uppermost portion.

4. The steering assembly of claim 1 wherein the rack bushing extended fluid channel is centered about the uppermost portion of the steering gear housing.

9. The steering assembly of claim 1 wherein the first fitting is circumferential spaced from the rack bushing extended fluid channel.

10. The steering assembly of claim 1 wherein the first fitting is circumferentially spaced substantially 180 degrees from the rack bushing extended fluid channel.

11. The steering assembly of claim 1 wherein the rack bushing main fluid channel extends an entire circumference about the outer surface of the rack bushing.

12. The steering assembly of claim 1 wherein the first fitting is disposed on the overlapping portion of the rack tube and the rack bushing.

13. The steering assembly of claim 12 wherein the first fitting is axially aligned with a portion of the rack bushing main fluid channel.

14. The steering assembly of claim 12 wherein the first fitting is axially offset from the rack bushing main fluid channel.

15. The steering assembly of claim 1 wherein the first fitting of the rack tube is axial spaced from the first chamber.

16. The steering assembly of claim 1 wherein the steering gear housing further comprises:
an outer surface having a steering gear housing main fluid channel extending circumferentially about the outer surface of the steering gear housing; and
a steering gear housing extended fluid channel extending axially along the outer surface of the steering gear housing from the steering gear housing main fluid channel to the second hydraulic chamber for allowing fluid flow between the second fitting and the second chamber.

17. The steering gear housing of claim 16 wherein the steering gear housing extended fluid channel is U-shaped.

18. The steering assembly of claim 1 wherein the outer surface of the steering gear housing has an uppermost portion, and the steering gear housing extended fluid channel is located within 45 degrees from the uppermost portion.

19. The steering assembly of claim 1 wherein the steering gear housing extended fluid channel is centered about the uppermost portion of the steering gear housing.

20. The steering assembly of claim 1 wherein the second fitting is circumferential spaced from the steering gear housing extended fluid channel.

21. The steering assembly of claim 1 wherein the second fitting is circumferentially spaced substantially 180 degrees from the steering gear housing extended fluid channel.

22. The steering assembly of claim 1 wherein the steering gear housing main fluid channel extends an entire circumference about the outer surface of the steering gear housing.

23. The steering assembly of claim 1 wherein the second fitting is disposed on the overlap portion of the rack tube and the steering gear housing.

24. The steering assembly of claim 23 wherein the second fitting is axially aligned with a portion of the steering gear housing main fluid channel.

25. The steering assembly of claim 22 wherein the second fitting is axially offset from the steering gear housing main fluid channel.

26. The steering assembly of claim 1 wherein the second fitting of the rack tube is axial spaced from the second chamber.

27. A steering gear assembly comprising:
a steering gear housing including an outer surface having a steering gear housing main fluid channel extending circumferentially about the outer surface of the steering gear housing;
a rack tube sealingly engaging the outer surface of the steering gear housing wherein a portion of the rack tube overlaps the main channel of the steering gear housing, the rack tube including a first aperture and a second aperture extending through a wall of the rack tube, the first aperture in fluid communication with the steering gear housing main fluid channel, and a first fitting and a second fitting extending radially outward from the rack tube, the second fitting in fluid communication with the steering gear housing main fluid channel through the second aperture;
a rack slidingly disposed in the rack tube and the steering gear housing;
a rack bushing disposed at a distal end of the rack from the steering gear housing;
a piston coupled to the rack;
a first hydraulic chamber formed between track bushing and the piston;
a rack seal disposed about the rack at an end portion of the steering gear housing defining a second hydraulic chamber within the rack tube between the rack seal and the piston; and
a steering gear housing extended fluid channel extending axially along the outer surface of the steering gear housing from the steering gear housing main fluid channel to the second hydraulic chamber for allowing fluid flow between the second fitting and the second chamber.

28. The steering gear assembly of claim 27 wherein the steering gear housing extended fluid channel is U-shaped.

29. The steering assembly of claim 27 wherein the rack bushing further comprises:
an outer surface having a rack bushing main fluid channel extending circumferentially about the outer surface of the rack bushing; and
a rack bushing extended fluid channel extending axially along the outer surface of the rack bushing from the rack bushing main fluid channel to the first hydraulic chamber for allowing fluid flow between the first fitting and the first chamber.

30. The steering gear assembly of claim 27 wherein the rack bushing extended fluid channel is U-shaped.

31. The steering assembly of claim 27 wherein the outer surface has an uppermost portion, and the extended fluid channel is located within 45 degrees from the uppermost portion.

32. A venturi passage for a steering gear assembly comprising:
a rack bushing including an outer surface having a rack bushing main fluid channel extending circumferentially about the outer surface of the rack bushing;
a steering gear housing disposed at a distal end from the rack bushing;
a rack tube sealingly engaging the outer surface of the rack bushing wherein a portion of the rack tube overlaps the rack bushing main fluid channel of the rack bushing, the rack tube including a first aperture and a second aperture extending through a wall of the rack tube, the first aperture in fluid communication with the rack bushing main fluid channel,
a first fitting extending radially outward from the rack tube, the first fitting in fluid communication with the rack bushing main fluid channel through the first aperture;
wherein the rack bushing main channel maintains fluid communication between the first fitting and the rack bushing extended fluid channel.

33. The venturi passage of claim 32 wherein the rack bushing extended fluid channel is U-shaped.

34. The venturi passage of claim 32 wherein rack tube further includes a second aperture extending through the wall of the rack tube, a second fitting extending radially outward from the rack tube, the steering gear housing includes an outer surface having a steering gear housing main fluid channel extending circumferentially about the outer surface of the steering gear housing, the steering gear housing further including a steering gear housing extended fluid channel extending axially along the outer surface of the steering gear housing from the steering gear housing main fluid channel to the first hydraulic chamber for maintaining fluid communication between the first fitting and the rack bushing extended fluid channel, said venturi passage further comprising a second fitting extending radially outward from the rack tube, the second fitting in fluid communication with the steering gear housing main fluid channel through the second aperture.

35. The venturi passage of claim 34 wherein the steering gear housing extended fluid channel is U-shaped.

36. The venturi passage of claim 32 wherein the outer surface has an uppermost portion, and the rack bushing extended fluid channel is located within 45 degrees from the uppermost portion.

37. The venturi passage of claim 32 wherein the first fitting is circumferential spaced from the rack bushing extended fluid channel.

38. The venturi passage of claim 32 wherein the rack bushing main fluid channel extends an entire circumference about the outer surface of the rack bushing.

39. The method of forming a venturi passage in a steering gear assembly, the method comprising the steps of:
forming a rack bushing main fluid channel in a rack bushing;
forming a rack bushing extended fluid channel at an uppermost portion of the rack bushing that extends axially along the outer surface of the rack bushing from the rack bushing main fluid channel to an end of the rack bushing;
sealingly engaging the rack tube to the outer surface of the rack bushing wherein a portion of the rack tube overlaps the rack bushing main fluid channel and the rack bushing extended fluid channel of the rack bushing; and
coupling a first fitting and a second fitting to the rack tube that extends radially outward from the rack tube, the first fitting is in fluid communication with the rack bushing main fluid channel, the first fitting is circumferentially spaced from the rack bushing extended fluid channel.

40. The method of claim 39 further comprising the steps of:
forming a steering gear housing main fluid channel in a steering gear housing that extends circumferentially about the outer surface of the steering gear housing;
forming a steering gear housing extended fluid channel at an uppermost portion of the steering gear housing that extends axially along the outer surface of the steering gear housing from the steering gear housing main fluid channel to an end of the steering gear housing;
sealingly engaging the rack tube to the outer surface of the steering gear housing wherein a portion of the rack tube overlaps the steering gear housing main fluid channel and the steering gear housing extended fluid channel of the steering gear housing; and
wherein the second fitting coupled to the rack tube is in fluid communication with the steering gear housing main fluid channel, the second fitting is circumferentially spaced from the steering gear housing extended fluid channel.
